(19) United States
(12) Patent Application Publication
(10) Pub. No.: US 2019/0205121 A1
(43) Pub. Date: Jul. 4, 2019

(54) DISTRIBUTED CODE REPOSITORY MANAGEMENT

(71) Applicant: PayPal, Inc., San Jose, CA (US)

(72) Inventor: Braden Christopher Ericson, San Jose, CA (US)

(21) Appl. No.: 15/856,352

(22) Filed: Dec. 28, 2017

(51) Int. Cl. G06F 8/71; G06Q 20/36; H04L 9/06

(52) U.S. Cl. CPC G06F 8/71; H04L 9/0643; H04L 9/0637; G06Q 20/3674

(57) ABSTRACT

Methods, systems, and computer devices are included for distributed code repository management. A method includes a validator node receiving a source code commit transaction from a developer node of a plurality of nodes. The source code commit transaction includes an indicator of a location corresponding to a signed software package and an indicator of a virtual currency amount. The validator node selects the source code commit transaction based on the virtual currency amount. The validator node validates the selected source code commit transaction by authenticating the developer node and comparing the signed software package to a previous version of a software package corresponding to the signed software package. The validator node generates a transaction ledger block corresponding to the validated source code commit transaction, and provides the generated transaction ledger block to one or more of the plurality of nodes.

### FIELD OF DISCLOSURE

The present disclosure generally relates to software package management and version control.

### BACKGROUND

A mechanism for source code distribution includes providing a centralized code repository where users may upload software packages, such as source code files and/or resource files relied upon by the source code. Traditionally these files are marked with a version number to distinguish between older and newer versions of the software. For example, as further development occurs with respect to the software, new software versions are released that include additional features and/or correct earlier defects in the software. These new software versions generally include updated version numbers to distinguish from the previous software versions. Central storage of code and versioning changes, however, is not always advantageous.

### BRIEF DESCRIPTION OF THE DRAWINGS

FIG. 1 is an organizational diagram illustrating a networked computing system including nodes that process a source code commit transaction and update a source code repository, in accordance with various examples of the present disclosure.

FIG. 2 is a flow diagram illustrating a method for performing a source code commit transaction, in accordance with various examples of the present disclosure.

FIG. 3 is an organizational diagram illustrating data structures corresponding to source code transactions, in accordance with various examples of the present disclosure.

FIG. 4 is an organizational diagram of a computing device, in accordance with various examples of the present disclosure.

Examples of the present disclosure and their advantages are best understood by referring to the detailed description that follows.

### DETAILED DESCRIPTION

in the following description, specific details are set forth describing some examples consistent with the present disclosure. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional.

According to the various aspects of the present disclosure, a method, system, and computer program product are described that provide distributed code repository management. Control of the distributed code repository management is shared among multiple users, such that no single entity is needed to oversee the entire code repository. As described herein, users may perform source code commit transactions that provide new software packages and updates to existing software packages to the distributed code repository. A source code commit transaction includes providing a link to a software package (or by providing the software package itself) to a plurality of networked computing nodes that are managed or owned by other users, in various embodiments. The software package may include one or more source code files and/or one or more software resource files relied upon by the source code, such as libraries, images, sounds, icons, and so forth.

A networked computing node selects the transaction for validation, according to various embodiments. The networked computing node may be incentivized to select the transaction by a virtual currency payment, where the amount of the virtual currency payment is specified in the submitted transaction. The networked computing node validates the transaction by authenticating the user or node that submitted the transaction and comparing the submitted software package to a previous version of the software package, in various embodiments.

Once the networked computing node validates the transaction, the networked computing node may provide the validated transaction to other networked computing nodes in a transaction ledger block. The networked computing nodes may append the transaction ledger block to a listing of previously generated transaction ledger blocks. In this way, a list of transactions is implemented, such that a plurality of nodes in the network maintain an accurate listing of updates to the code repository. This transaction listing may be accessed by nodes in the network to identify the developers of software packages, locations of software packages and versioning information corresponding to the software packages, such as the identity of the most recent versions of the software packages and changes from previous versions of the software packages.

The techniques herein provide useful advantages to code repository technology. For instance, the techniques allow the code repository to be de-centralized and for management of the code repository to be spread among the users of the code repository. This reduces management overhead and upkeep costs by obviating the need for centralized servers. Thus, processing and storage resource costs are reduced, yielding efficiency improvements to the computing system providing the code repository. Moreover, the code repository is improved because it does not have a single point of failure, and is therefore less susceptible to failure and more resilient to errors that may occur to any particular nodes in the network. For example, thousands or even millions of computing devices may share responsibility for management of the code repository, such that even the total failure of any machine in the network has little impact on the code repository. Of course, it is understood that these features and advantages are shared among the various examples herein and that no one feature or advantage is required for any particular embodiment.

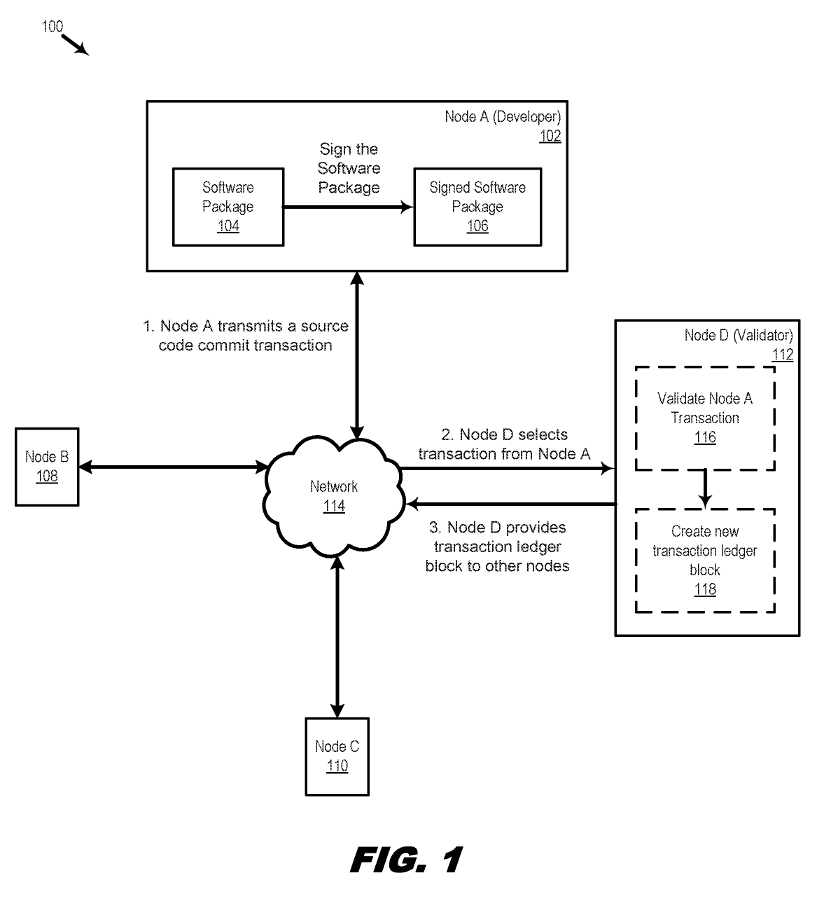

FIG. 1 is a networked computing system 100 including nodes that process a source code commit transaction and update a source code repository.

The system 100 includes a plurality of nodes that are each structured with a non-transitory memory. The plurality of nodes are each structured with one or more hardware processors coupled to the non-transitory memory that are configured to read instructions from the non-transitory memory to perform the operations described herein. In the present example, the nodes are communicatively coupled in a peer-to-peer network.

The system 100 includes Node A 102 that is structured as a computing device of a developer user. Node A 102 may include one or more developer tools, such as compilers, debuggers, and/or linkers. The developer uses Node A 102 to create a software package 104 that includes one or more source code files and/or software resource files (e.g., libraries, images, sounds, icons, and so forth). In some examples, the software package 104 includes executable files.

Node A 102 signs the software package 104 to create a signed software package 106. The signed software package 106 is structured to include a signature and also the contents of the software package 104. In the present example, the signature includes a string of text that verifies the authenticity of the software package 104 that is included with the signature. In some examples, the signature is generated by inputting a signing key, such as a private key, of the developer into an encryption function along with a hash generated from the software package 104. In some examples, the signature also includes other encrypted information, such as a public key of the developer. Accordingly, the signature, when decrypted, may provide information regarding the contents of the signed software package 106 as well as information regarding the developer that provided the signed software package 106.

In the present example, Node A 102 creates a source code commit transaction to update a code repository to include the signed software package 106. In the present example, the source code commit transaction includes an identifier of the developer or Node A as well as a link to the signed software package 106. In some examples, the link is encrypted to provide an encrypted hash corresponding to a location where the signed software package 106 is stored. In other examples, rather than a link the source code commit transaction may include the contents of the signed software package 106.

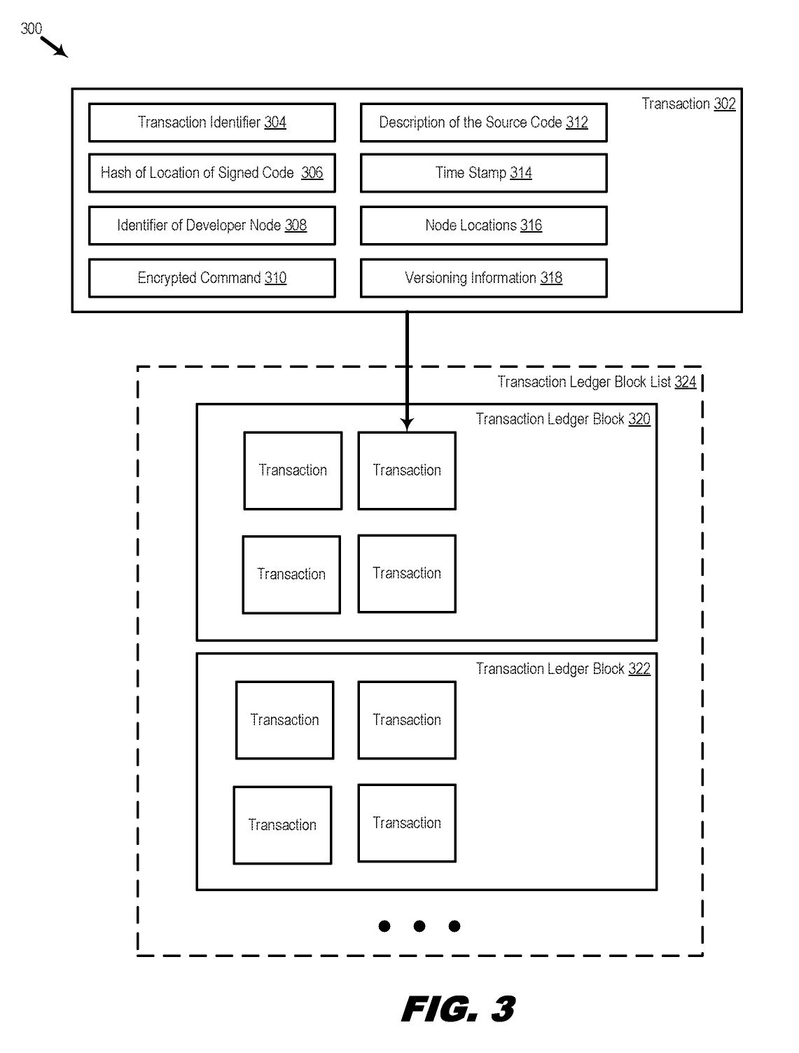

Examples of data that may be included in a transaction are described in further detail with respect to FIG. 3. For example, a transaction may provide a command that indicates an action for the code repository to take regarding the transaction. Examples of commands include a “push” command to update the code repository with a new or modified software package, a “branch” command to create a new branch corresponding to a software package, and a “checkout” command to reserve one or more files of a software package for a particular user.

In some examples, the transaction is structured as a smart contract. In more detail, the transaction submitted by Node A 102 may include terns that are written into the code of the transaction. The terms in the transaction are executed by a recipient of the transaction to carry out the transaction. For example, terms in the submitted transaction may include terms that are executed to authenticate the developer or Node A 102, update a transaction ledger to include the transaction, push the signed software package 106 to other nodes, and transfer a payment of virtual currency from the developer to the recipient.

In some examples, the transaction includes an indication of an amount of virtual currency to transfer from the developer to a user of a node that validates the transaction. For example, the developer may have a digital wallet that holds virtual currency, and may designate an amount of the virtual currency to be withdrawn and paid to the user whose node validates the transaction.

In the present example, the system 100 is structured with multiple distributed nodes that are available to validate the transaction. Accordingly, the transaction is sent from Node A 102, via a multicast data transmission over a network 114, to multiple other nodes that add the transaction into a pool of pending transactions that are awaiting validation. In the present example, Node B 108, Node C 110, and Node D 112 are available to validate the transaction that is temporarily placed in the pool of transactions. In other examples, there may be thousands (or more) nodes available to validate the pending transactions.

In some examples, Node B 108, Node C 110, and Node D 112 are primarily used for validating transactions. In some examples, these nodes act as miner nodes by receiving payment in virtual currency for validating the transactions. In some examples, Node A 102 may also be used to validate transactions, and one or more of Node B 108, Node C 110, or Node D 112 may be used to develop source code, provide software packages, and generate transactions for processing by other nodes.

In the present example, Node B 108, Node C 110, and Node D 112 determine an amount of virtual currency that will be awarded for processing each transaction. For example, Node D 112 parses the virtual currency amount from the source code commit transaction. In this way, the nodes are able to determine which transaction will yield the highest virtual currency award. In this example, the source code commit transaction is associated with the highest virtual currency amount, and therefore Node D 112 selects the source code commit transaction from the pool of transactions.

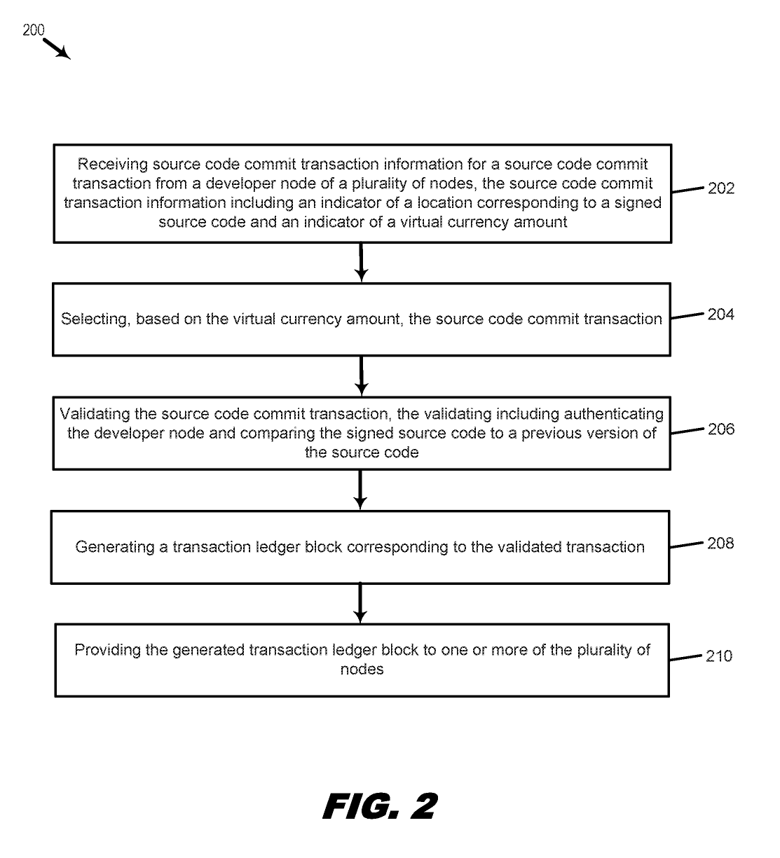

Node D 112 is structured to validate the Node A transaction (block 116) and to create a new transactional ledger block that includes the transaction (block 118). In some examples, Node D 112 validates the Node A transaction by executing the smart contract provided by the transaction. Techniques for validating transactions and creating transaction ledger blocks are described in more detail with respect to FIG. 2. An example structure of the validated transaction that is included in the transaction ledger block is shown with respect to FIG. 3. Node D 112 is structured to provide, via a multicast data transmission, the signed software package 106 and the created transaction ledger block to other nodes (e.g., Node B 108 and Node C 110). In this way, other nodes in the distributed network are made aware of the completed transaction regarding the signed software package 106 and provided access to the signed software package 106.

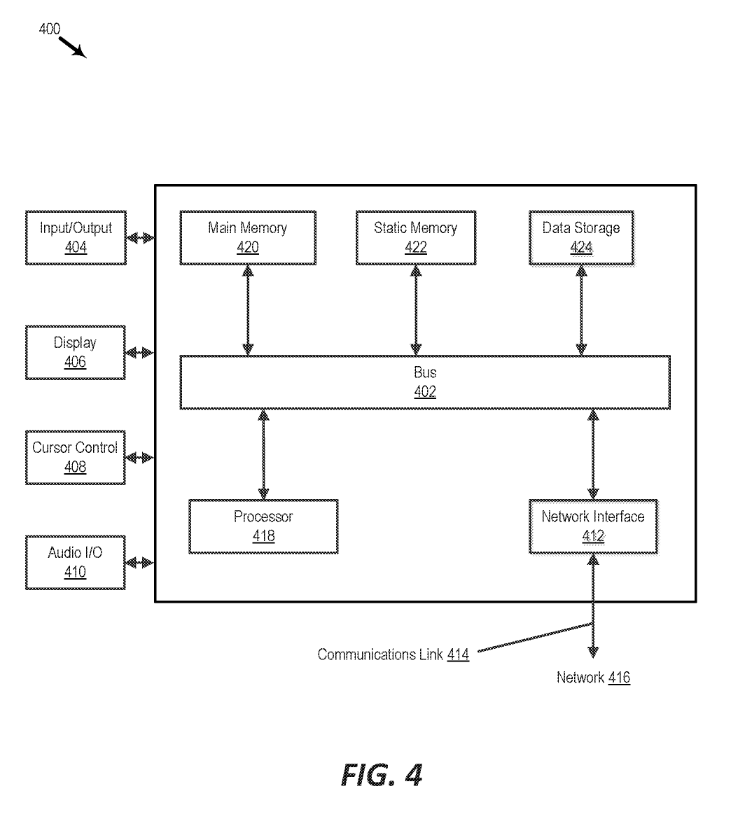

FIG. 2 is a flow diagram illustrating a method 200 for performing a source code commit transaction, in accordance with various examples of the present disclosure. In some examples, the method is performed by executing computer-readable instructions that are stored in a non-transitory memory using one or more processors. The non-transitory memory and processors may be provided by, for example, one or more of the computing devices 400 as described with respect to FIG. 4, as implemented to provide network nodes in a system 100 as described with respect to FIG. 1. Additional steps may be provided before, during, and after the steps of method 200, and some of the steps described may be replaced, eliminated and/or re-ordered for other examples of the method 200.

At action 202, a validator node in a peer-to-peer network receives a source code commit transaction from a developer node. In the present example, the developer node includes a computing device that is used by a developer user to generate transactions, such as a source code commit transaction. In the present example, the validator node is one of a plurality of validator nodes that receives virtual currency payments to validate transactions received from other nodes. In other examples, other transactions may be received in addition to, or instead of, source code commit transactions.

In the present example, the source code commit transaction identifies a location of a signed software package and an indicator of a virtual currency amount. In some examples, the location identifier includes a Uniform Resource Locator (URL) web address, network drive identifier, directory identifier, file path, or other identifier that specifies a location corresponding to the signed software package. In some examples, the location identifier is provided in an encrypted format as a hash that may be decrypted to provide the location of the signed software package. In other examples, the signed software package itself is provided in the source code commit transaction.

In more detail regarding the signed software package, the signed software package may include a signature and a software package comprising one or more source code files and/or one or more resource files, such as libraries, images, sounds, icons, and so forth. For example, the signed software package may include a signed source code file. In the present example, the signature is generated for the software package using an asymmetrical cryptography technique, such as via a Public Key Infrastructure (PKI) that assigns the developer a key pair including a private key and a public key. In this example, the developer generates the signature for the software package using the developer's private key. The public key is distributed to other nodes that use the public key to verify the signature. Examples of cryptography techniques for generating and verifying signatures include DSA, Elliptic Curve Signature, RSA, and so forth.

At action 204, the validator node selects, based on the virtual currency amount, the source code commit transaction for validation. In the present example, the validator node accesses a pool of pending transactions and reads virtual currency amounts from the pending transactions. The validator node then selects a pending transaction that specifies a highest amount of virtual currency. In some examples, the validator node may indicate to one or more other validator nodes that the validator node is validating the source code commit transaction, such that the other validator nodes may be alerted to avoid duplicating the efforts of the validator node with respect to the selected transaction.

At action 206, the validator node validates the source code commit transaction. In some examples, the validating includes executing terms in the transaction via a smart contract protocol. These terms may include lines of code that are executed to authenticate the developer that provided the transaction, comparing the signed software package to a previous version of the software package, and pushing the signed software package to other nodes.

In some examples, authenticating the developer includes accessing a public key corresponding to the developer by retrieving the public key from the transaction itself (if provided by the developer in the transaction), or by retrieving the public key from a listing of public keys that is accessible to the validator node via a network location. Once the public key is retrieved, the validator node inputs the signature and the public key into a signature verification function (e.g., DSA, Elliptic Curve Signature, RSA, and so forth) to decrypt the digital signature.

Once decrypted, the validator node compares information from the decrypted signature with other information to verify the authenticity of the software package. For example, the decrypted digital signature may include the public key, a checksum computed from the source code, and/or some other value that the validator may compare to validate that the source code package was signed using the private key that is part of the same key pair as the retrieved public key.

In more detail, the decrypted signature may provide the developer's public key and a hash corresponding to the software package. The validator node may compare the public key to the public key used to decrypt the signature to verify the authenticity of the developer. The validator may compare the hash retrieved from the decrypted signature with a hash that the validator node generates from the software package to verify that the contents of the software package have not been tampered with or otherwise modified, such as by an unauthorized user, entity, or software program. Techniques for generating the hash from the software package include MD5, SHA-1, and so forth.

In the present example, the validator node also compares the software package with a previous version of the software package to identify differences over time. The comparing may include generating a difference file that identifies added files, deleted files, changes in lines of source code (of one or more source code files), and other differences. In some examples, once the software package is authenticated and compared with a previous software package, the transaction is considered validated, and the software package may then be pushed to other nodes in the network.

At action 208, the validator node generates a transaction ledger block corresponding to the validated transaction. In the present example, the validator node provides the transaction, in a transaction ledger block that includes one or more other transactions that have been validated by the validator node. In some examples, the transaction that is included in the transaction ledger block includes the information that is described in more detail with respect to FIG. 3.

In the present example, the validator node assigns the transaction a transaction identifier. In some examples, the validator node assigns the transaction identifier by accessing one or more hashes included in previous transaction ledger blocks to perform a proof of work. In more detail, the proof of work may include generating a hash that includes contents from the transaction ledger and also a hash of a previous transaction ledger block. The proof of work helps protect the transaction ledger block (and the previous transaction ledger blocks) from tampering because it provides a cryptographic link between the transaction ledger block and previous transaction ledger blocks. In that regard, the hashes in the transaction identifiers help ensure that even minor changes in the previous transaction ledger block result in a different hash, thereby indicating the existence of the tampering. Moreover, if a previous transaction ledger block is tampered with, it may be identified as out of place in the linked transaction ledgers because other nodes in the network will have copies of the previous transaction ledger block that do not match the tampered-with previous transaction ledger.

At action 210, the validator node provides the generated transaction ledger block to one or more of the plurality of nodes. In the present example, the validator node includes the transaction ledger block in a listing of previous transaction ledger block, and provides the transaction ledger blocks to the other nodes so that the other nodes may similarly include the transaction ledger block in their listings of previous transaction ledger blocks. In this way, the various nodes in the distributed network are able to maintain an up-to--date listing of the transactions affecting the code repository.

The nodes in the network may access the transaction ledger blocks to identify a current version of a software package, identify changes that have been made to the various packages in the code repository, and so forth. For example, a node may determine that a most recent version of a software package by identifying the transaction ledger block that specifies that software package and has a most recent time stamp. Accordingly, to retrieve that most recent version of the software package, the node may access a location identifier from the transaction ledger block and download the software package from that location.

FIG. 3 is an organizational diagram illustrating data structures 300 corresponding to source code transactions, in accordance with various examples of the present disclosure. These data structures may be used to provide the transaction ledgers described with respect to FIGS. 1 and 2.

Transaction 302 includes data that describes a requested update to a code repository. For example, the transaction 302 may correspond to a source code commit transaction that pushes a new file or an update to an existing file to the distributed code repository. In another example, transaction 302 may correspond to a rollback transaction, to revert/undo a previously committed transaction. In yet another example, a transaction 302 may correspond to a branch transaction that identifies a fork regarding a source code update.

In the present example, the data included in the transaction 302 includes a transaction identifier 304. In some examples, the transaction identifier 304 includes a hash of one or more of the following: a hash of a location of a signed code 306 (or of another type of software file), an identifier of a developer node 308, an encrypted command 310, a description of the source code 312, a time stamp 314, a node locations 316 field, or versioning information 318. In some examples, the transaction identifier 304 also takes into account one or more hashes of previous transactions. The hash may be taken into account by providing a hash tree where leaf nodes in the hash tree are labeled with a hash of a previous transaction, and the non-leaf nodes are labeled with the hashes of labels of their respective child nodes. In this example, the root node (e.g., the top hash) corresponds to the transaction identifier 304 of the transaction 302.

In the present example, the hash of a location of signed code 306 is a hash of a Uniform Resource Locator (URL) or other identifier of a network location where signed code is stored corresponding to the transaction 302. For example, in a source code commit transaction, new or updated code to be added to the code repository is stored at location in the network, and a string that indicates the location is encrypted to generate the hash of the location of signed code 306.

In the present example, the identifier of the developer node 308 specifies an identifier of a user and/or a node that initiated the transaction 302. For example, in a source code commit transaction, the identifier of the developer node 308 may include a username of the developer that created the source code, or an identifier of a user or a computing device that submitted the source code commit transaction to a validating node to push the source code to a distributed code repository.

In the present example, the encrypted command 310 is an encrypted string of the command corresponding to the transaction 302. For example, if the transaction 302 is a source code commit transaction, the command may be to perform a “push,” and therefore the “push” string may be encrypted as the encrypted command 310. In another example, if the transaction is a “rollback” transaction, the “rollback” string may be encrypted as the encrypted command 310, Various strings or other non-string identifiers may be used to specify a particular command, which may be encrypted. In other examples, the command may be specified as a plain text command, which is thereby publically accessible to nodes in the network.

In the present example, the description of source code 312 includes text that provides a description of the contents of the source code and/or describes updates to the source code that are provided by the transaction 302.

In the present example, the time stamp 314 specifies a time corresponding to the transaction, such as a time that the transaction was submitted for validation. In some examples, the time stamp specifies a year, month, day, hour, minute, and second corresponding to the transaction 302. In other examples, the time stamp 314 may provide additional granularity beyond specifying the second (e.g., microsecond, and so forth).

In the present example, the node locations 316 field identifies one or more nodes in the network that maintain transaction ledgers. The nodes may be identified by their Internet Protocol (IP) addresses, network names, or other network identifier. In the present example, the versioning information 318 identifies a version number corresponding to the source code. This versioning information may distinguish between major and minor versions (e.g., 1.4 may indicate that a software package is minor update 4 to major version 1).

In the present example, a transaction ledger block 320 includes a plurality of transactions that are aggregated into the transaction ledger block 320. The transaction ledger block 320 is provided to a plurality of nodes to be included with previous transaction ledger blocks (e.g., transaction ledger block 322) in a transaction ledger block list 324. In the present example, the transaction ledger block list 324 is a complete listing of transactions for the code repository. In some examples, the transaction ledger block 320 is considered complete and ready to submit to other nodes for inclusion in the transaction ledger block list 324 when a pre-defined threshold amount of transactions are included in the transaction ledger block 320.

FIG. 4 is an organizational diagram of a computing device 400 suitable for implementing one or more networked computing nodes of a system (e.g., networked computing system 100). In various implementations, computing device 400 may provide a computing device, such as a smart or mobile phone, a computing tablet, a desktop computer, laptop, wearable device, rack mount server, or other computing device.

Computing device 400 may include a bus 402 or other communication mechanisms for communicating information data, signals, and information between various components of computing device 400. Components include an I/O component 404 that processes a user action, such as selecting keys from a keypad/keyboard, selecting one or more buttons, links, actuatable elements, etc., and sends a corresponding signal to bus 402. I/O component 404 may also include an output component, such as a display 406 and a cursor control 408 (such as a keyboard, keypad, mouse, touch screen, etc.). An optional audio I/O component 410 may also be included to allow a user to hear audio and/or use voice for inputting information by converting audio signals.

A network interface 412 transmits and receives signals between computing device 400 and other devices, such as user devices, data storage servers, payment provider servers, and/or other computing devices via a communications link 414 and a network 416 (e.g., such as a LAN, WLAN, PTSN, and/or various other wired or wireless networks, including telecommunications, mobile, and cellular phone networks).

The processor 418 represents one or more general-purpose processing devices such as a microprocessor, central processing unit, or the like. More particularly, processor 418 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 418 may also be one or more special-purpose processing devices such as an application specific integrated circuit (ASIC), a field programmable gate array (FPGA), a digital signal processor (DSP), network processor, or the like. Processor 418 is configured to execute instructions for performing the operations and steps discussed herein.

Components of computing device 400 also include a main memory 420 (e.g., read-only memory (ROM), flash memory, dynamic random access memory (DRAM) such as synchronous DRAM (SDRAM), double data rate (DDR SDRAM), or DRAM (RDRAM), and so forth), a static memory 422 (e.g., flash memory, static random access memory (SRAM), and so forth), and a data storage device 424 (e.g., a disk drive).

Computing device 400 performs specific operations by processor 418 and other components by executing one or more sequences of instructions contained in main memory 420. Logic may be encoded in a computer readable medium, which may refer to any medium that participates in providing instructions to processor 418 for execution. Such a medium may take many forms, including but not limited to, non-volatile media, volatile media, and/or transmission. media. In various implementations, non-volatile media includes optical or magnetic disks, volatile media includes dynamic memory, such as main memory 420, and transmission media between the components includes coaxial cables, copper wire, and fiber optics, including wires that comprise bus 402. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computing device 400. In various other embodiments of the present disclosure, a plurality of computing devices coupled by communication link 414 to the network 416 may perform instruction sequences to practice the present disclosure in coordination with one another. Modules described herein may he embodied in one or more computer readable media or be in communication with one or more processors to execute or process the steps described herein.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure. Although illustrative examples have been shown and described, a wide range of modification, change and substitution is contemplated in the foregoing disclosure and in some instances, some features of the examples may be employed without a corresponding use of other features. In some instances, actions may be performed according to alternative orderings. One of ordinary skill in the art would recognize many variations, alternatives, and modifications. Thus, the scope of the invention should be limited only by the following claims, and it is appropriate that the claims be construed broadly and in a manner consistent with the scope of the examples disclosed herein.

1. A system, comprising:
a non-transitory memory; and
one or more hardware processors coupled to the non-transitory memory and configured to read instructions from the non-transitory memory to cause the system to perform operations comprising:
receiving a source code commit transaction from a developer node of a plurality of nodes, the source code commit transaction including an indicator of a location corresponding to a signed source code and an indicator of a virtual currency amount;
selecting, based on the virtual currency amount, the source code commit transaction;
validating the selected source code commit transaction, the validating including authenticating the developer node and comparing the signed source code to a previous version of a source code corresponding to the signed source code;
generating a transaction ledger block corresponding to the validated source code commit transaction; and
providing the generated transaction ledger block to multiples multiple nodes of the plurality of nodes.

2. The system of claim 1, wherein the signed source code includes a signature generated using the source code and a private key of the developer node and wherein the source code comprises instructions to perform operations executable by a processor when compiled using a compiler or a linker.

3. The system of claim 1, wherein the source code commit transaction is received via a multicast data transmission, and wherein the indicator of the location comprises a hash value.

4. The system of claim 1, wherein the virtual currency amount is transferred to a digital wallet of a user of a node of the plurality of nodes that validates the source code commit transaction.

5. The system of claim 1, wherein the generated transaction ledger block includes a transaction identifier, the indicator of the location corresponding to the signed source code, an identifier of the developer node, and a time stamp.

6. The system of claim 1, wherein the generated transaction ledger block includes an encrypted command corresponding to the received signed source code, and wherein the encrypted command includes a push command.

7. The system of claim 1, wherein the generated transaction ledger block includes data corresponding to a plurality of completed source code commit transactions, and wherein the transaction ledger block is appended to a list comprising a plurality of transaction ledger blocks.

8. The system of claim 1, wherein the providing of the generated transaction ledger block includes appending the generated transaction ledger block to a listing of a plurality of transaction ledger blocks.

9. A non-transitory machine-readable medium having stored thereon machine-readable instructions executable to cause a machine to perform operations comprising:
receiving a source code commit transaction from a developer node of a plurality of nodes, the source code commit transaction including an indicator of a location . corresponding to a signed software package and an indicator of a virtual currency amount;
selecting, based on the virtual currency amount, the source code commit transaction;
validating the selected source code commit transaction, the validating including authenticating the developer node and comparing the signed software package to a previous version of a software package corresponding to the signed software package;
generating a transaction ledger block corresponding to the validated source code commit transaction; and
providing the generated transaction ledger block to multiple nodes of the plurality of nodes.

10. The non-transitory machine-readable medium of claim 9, wherein the signed software package includes a signature generated using the signed software package and a private key of the developer node.

11. The non-transitory machine-readable medium of claim 9, wherein the source code commit transaction is received via a multicast data transmission, and wherein the indicator of the location comprises a hash value.

12. The non-transitory machine-readable medium of claim 9, wherein the virtual currency amount is transferred to a digital wallet of a user of a node of the plurality of nodes that validates the source code commit transaction.

13. The non-transitory machine-readable medium of claim 9, wherein the generated transaction ledger block includes a transaction identifier, the indicator of the location corresponding to the signed software package, an identifier of the developer node, and a time stamp.

14. The non-transitory machine-readable medium of claim 9, wherein the generated transaction ledger block includes an encrypted command corresponding to the received signed software package, and wherein the encrypted command includes a push command.

15. The non-transitory machine-readable medium of claim 9, wherein the generated transaction ledger block includes data corresponding to a plurality of completed source code commit transactions, and wherein the transaction ledger block is appended to a list comprising a plurality of transaction ledger blocks.

16. A method comprising:
receiving a source code commit transaction from a developer node of a plurality of nodes, the source code commit transaction including an indicator of a location corresponding to a signed software package;
selecting the source code commit transaction;
validating the selected source code commit transaction, the validating including authenticating the developer node and comparing the signed software package to a previous version of a software package corresponding to the signed software package;
generating a transaction ledger block corresponding to the validated source code commit transaction; and
providing the generated transaction ledger block to multiple nodes of the plurality of nodes.

17. The method of claim 16, wherein a virtual currency amount is transferred to a digital wallet of a user of a node of the plurality of nodes as payment for validating the source code commit transaction.

18. The method of claim 16, wherein the generated transaction ledger block includes a transaction identifier, the indicator of the location corresponding to the signed software package, an identifier of the developer node, and a time stamp.

19. The method of claim 16, wherein the transaction ledger block includes an encrypted command corresponding to the received signed software package, and wherein the encrypted command includes a push command.

20. The method of claim 16, wherein the transaction ledger block includes data corresponding to a plurality of completed source code commit transactions, and wherein the transaction ledger block is appended to a list comprising a plurality of transaction ledger blocks.
